(19) United States
(12) Patent Application Publication
(10) Pub. No.: US 2021/0133996 A1
(43) Pub. Date: May 6, 2021

(54) TECHNIQUES FOR MOTION-BASED AUTOMATIC IMAGE CAPTURE

(71) Applicant: SZ DJI TECHNOLOGY CO., LTD., Shenzhen (CN)

(72) Inventors: You ZHOU, Shenzhen (CN); Jie LIU, Shenzhen (CN); Jinzhu HUANG, Shenzhen (CN)

(21) Appl. No.: 17/144,594

(22) Filed: Jan. 8, 2021

Related U.S. Application Data
(63) Continuation of application No. PCT/CN2018/098131, filed on Aug. 1, 2018.

(51) Int. Cl. G06T 7/593; B64C 39/02; G06K 9/32; G06N 20/00; G06T 7/521; G06T 7/579; G06F 3/0488; G06T 7/00

(52) U.S. Cl. CPC G06T 7/593; B64C 39/024; G06K 9/3233; G06N 20/00; B64C 2201/127; G06T 7/579; G06F 3/04883; G06T 7/0002; G06T 7/521

(57) ABSTRACT

Techniques are disclosed for motion-based automatic image capture in a movable object environment Image data including a plurality of frames can be obtained and a region of interest in the plurality of frames can be identified. The region of interest may include a representation of one or more objects. Depth information for the one or more objects can be determined in a first coordinate system. A movement characteristic of the one or more objects may then be determined in the second coordinate system based at least on the depth information. One or more frames from the plurality of frames may then be identified based at least on the movement characteristic of the one or more objects.

### CROSS REFERENCE TO RELATED APPLICATION

This application is a continuation application of International Application PCT/CN2018/098131, filed Aug. 1, 2018, entitled, “TECHNIQUES FOR MOTION-BASED AUTOMATIC IMAGE CAPTURE” which is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The disclosed embodiments relate generally to techniques for image capture and more particularly, but not exclusively, to motion-based and/or direction-based techniques for automatic image capture of target objects.

### BACKGROUND

Aerial vehicles such as unmanned aerial vehicles (UAVs) can be used for performing surveillance, reconnaissance, and exploration tasks for various applications. Movable objects may include a payload, such as a camera, which enables the movable object to capture image data during movement of the movable objects. The captured image data may be viewed on a client device, such as a client device in communication with the movable object via a remote control, remote server, or other computing device. A user may then control the movable object or otherwise provide instructions to the movable object based on the image data being viewed.

### SUMMARY

Techniques are disclosed for motion-based automatic image capture in a movable object environment. Image data including a plurality of frames can be obtained and a region of interest in the plurality of frames can be identified. The region of interest may include a representation of one or more objects. Depth information for the one or more objects can be determined in a first coordinate system. A movement characteristic of the one or more objects may then be determined in the second coordinate system based at least on the depth information. One or more frames from the plurality of frames may then be identified based at least on the movement characteristic of the one or more objects.

### BRIEF DESCRIPTION OF DRAWINGS

FIG. 1 illustrates an example of a movable object in a movable object environment, in accordance with various embodiments of the present invention.

FIG. 2 illustrates an example of a movable object architecture in a movable object environment, in accordance with various embodiments of the present invention.

FIG. 3 illustrates an example of image capture of a target object in a movable object environment, in accordance with various embodiments of the present invention.

FIG. 4 illustrates an example of projection of a representation of a target object in a world coordinate system to a pixel coordinate system, in accordance with various embodiments of the present invention.

FIG. 5 illustrates target object tracking, in accordance with various embodiments of the present invention.

FIG. 6 illustrates determining a movement magnitude characteristic of a region of interest, in accordance with various embodiments of the present invention.

FIG. 7 illustrates determining a movement direction characteristic of a region of interest, in accordance with various embodiments of the present invention.

FIG. 8 illustrates an example of determining a depth of a target object, in accordance with various embodiments of the present invention.

FIG. 9 illustrates an example of determining a depth of a target object, in accordance with various embodiments of the present invention.

FIG. 10 illustrates an example of determining a movement tendency of a bounding box using depth-based movement thresholds, in accordance with various embodiments of the present invention.

FIG. 11 illustrates an example of selecting image data based on the movement tendency of the bounding box, in accordance with various embodiments of the present invention.

FIGS. 12A and 12B illustrate example systems for automatic image capture based on movement, in accordance with various embodiments of the present invention.

FIG. 13 illustrates an example of supporting a movable object interface in a software development environment, in accordance with various embodiments of the present invention.

FIG. 14 illustrates an example of an unmanned aircraft interface, in accordance with various embodiments of the present invention.

FIG. 15 illustrates an example of components for an unmanned aircraft in a software development kit (SDK), in accordance with various embodiments of the present invention.

FIG. 16 shows a flowchart of communication management in a movable object environment, in accordance with various embodiments of the present invention.

### DETAILED DESCRIPTION

The invention is illustrated, by way of example and not by way of limitation, in the figures of the accompanying drawings in which like references indicate similar elements. It should be noted that references to “an” or “one” or “some” embodiment(s) in this disclosure are not necessarily to the same embodiment, and such references mean at least one.

The following description of the invention describes an onboard computing device for a movable object. For simplicity of explanation, an unmanned aerial vehicle (UAV) is generally used as example of a movable object. It will be apparent to those skilled in the art that other types of movable objects can be used without limitation.

Embodiments enable a movable object to automatically capture image data based on the movement of representations of real-world objects in the image data. Techniques exist for determining whether image data is showing movement or static. However, these techniques generally rely on fixed assumptions about the scene being filmed. For example, a fixed distance between the camera and the objects shown in the image data is assumed under existing techniques. However, movable objects are, by their nature, movable. As such, a distance between the movable object and a target object cannot be assumed, making it difficult to determine whether objects represented in the image data are moving, and if so, by how much (e.g., a small perceived movement of a distant object may actually correspond to a large movement of that object, while a large perceived movement of a close object may actually correspond to a small movement of that object). Embodiments address the shortcomings of existing techniques by collecting and utilizing real-world depth information for object of interest to more accurately analyze the movement of those objects in an image plane.

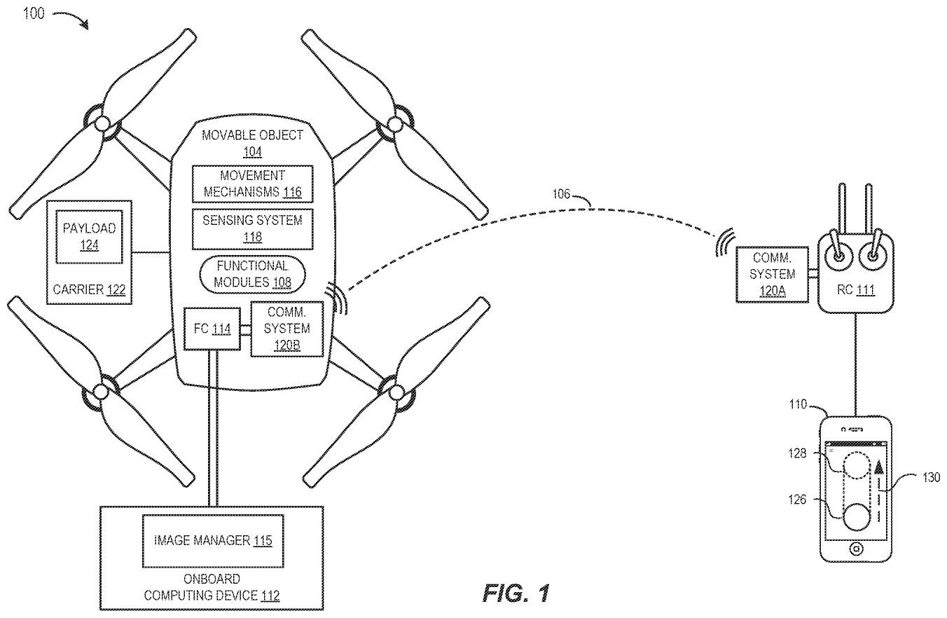

FIG. 1 illustrates an example of an application in a movable object environment 100, in accordance with various embodiments of the present invention. As shown in FIG. 1, client device 110 in a movable object environment 100 can communicate with a movable object 104 via a communication link 106. The movable object 104 can be an unmanned aircraft, an unmanned vehicle, a handheld device, and/or a robot.

As shown in FIG. 1, the client device 110 can be a portable personal computing device, a smart phone, a remote control, a wearable computer, a virtual reality/augmented reality system, and/or a personal computer. Additionally, the client device 110 can include a remote control 111 and communication system 120A, which is responsible for handling the communication between the client device 110 and the movable object 104 via communication system 120B. For example, an unmanned aircraft can include uplink and downlink. The uplink can be used for transmitting control signals, the down link can be used for transmitting media or video stream. As discussed further, client device 110 and movable object 104 may each include a communications router which determines how to route data received over the communication link 106, e.g., based on data, contents, protocol, etc.

In accordance with various embodiments of the present invention, the communication link 106 can be (part of) a network, which is based on various wireless technologies, such as the WiFi, Bluetooth, 3G/4G, and other radio frequency technologies. Furthermore, the communication link 106 can be based on other computer network technologies, such as the internet technology, or any other wired or wireless networking technology. In some embodiments, the communication link 106 may be a non-network technology, including direct point-to-point connections such as universal serial bus (USB) or universal asynchronous receiver-transmitter (UART).

In various embodiments, movable object 104 in a movable object environment 100 can include a carrier 122 and a payload 124. Although the movable object 104 is described generally as an aircraft, this is not intended to be limiting, and any suitable type of movable object can be used. One of skill in the art would appreciate that any of the embodiments described herein in the context of aircraft systems can be applied to any suitable movable object (e.g., a UAV). In some instances, the payload may be provided on the movable object 104 without requiring the carrier.

In accordance with various embodiments of the present invention, the movable object 104 may include one or more movement mechanisms 116 (e.g. propulsion mechanisms), a sensing system 118, and a communication system 120B. The movement mechanisms 116 can include one or more of rotors, propellers, blades, engines, motors, wheels, axles, magnets, nozzles, animals, or human beings. For example, the movable object may have one or more propulsion mechanisms. The movement mechanisms may all be of the same type. Alternatively, the movement mechanisms can be different types of movement mechanisms. The movement mechanisms 116 can be mounted on the movable object 104 (or vice-versa), using any suitable means such as a support element (e.g., a drive shaft). The movement mechanisms 116 can be mounted on any suitable portion of the movable object 104, such on the top, bottom, front, back, sides, or suitable combinations thereof.

In some embodiments, the movement mechanisms 116 can enable the movable object 104 to take off vertically from a surface or land vertically on a surface without requiring any horizontal movement of the movable object 104 (e.g., without traveling down a runway). Optionally, the movement mechanisms 116 can be operable to permit the movable object 104 to hover in the air at a specified position and/or orientation. One or more of the movement mechanisms 116 may be controlled independently of the other movement mechanisms, for example by an application executing on client device 110, onboard computing device 112, or other computing device in communication with the movement mechanisms. Alternatively, the movement mechanisms 116 can be configured to be controlled simultaneously. For example, the movable object 104 can have multiple horizontally oriented rotors that can provide lift and/or thrust to the movable object. The multiple horizontally oriented rotors can be actuated to provide vertical takeoff, vertical landing, and hovering capabilities to the movable object 104. In some embodiments, one or more of the horizontally oriented rotors may spin in a clockwise direction, while one or more of the horizontally oriented rotors may spin in a counterclockwise direction. For example, the number of clockwise rotors may be equal to the number of counterclockwise rotors. The rotation rate of each of the horizontally oriented rotors can be varied independently in order to control the lift and/or thrust produced by each rotor, and thereby adjust the spatial disposition, velocity, and/or acceleration of the movable object 104 (e.g., with respect to up to three degrees of translation and up to three degrees of rotation). As discussed further herein, a controller, such as flight controller 114, can send movement commands to the movement mechanisms 116 to control the movement of movable object 104. These movement commands may be based on and/or derived from instructions received from client device 110, onboard computing device 112, or other entity.

The sensing system 118 can include one or more sensors that may sense the spatial disposition, velocity, and/or acceleration of the movable object 104 (e.g., with respect to various degrees of translation and various degrees of rotation). The one or more sensors can include any of the sensors, including GPS sensors, motion sensors, inertial sensors, proximity sensors, or image sensors. The sensing data provided by the sensing system 118 can be used to control the spatial disposition, velocity, and/or orientation of the movable object 104 (e.g., using a suitable processing unit and/or control module). Alternatively, the sensing system 118 can be used to provide data regarding the environment surrounding the movable object, such as weather conditions, proximity to potential obstacles, location of geographical features, location of manmade structures, and the like.

The communication system 120B enables communication with client device 110 via communication link 106, which may include various wired and/or wireless technologies as discussed above, and communication system 120A. The communication system 120A or 120B may include any number of transmitters, receivers, and/or transceivers suitable for wireless communication. The communication may be one-way communication, such that data can be transmitted in only one direction. For example, one-way communication may involve only the movable object 104 transmitting data to the client device 110, or vice-versa. The data may be transmitted from one or more transmitters of the communication system 120A of the client device to one or more receivers of the communication system 120B of the movable object, or vice-versa. Alternatively, the communication may be two-way communication, such that data can be transmitted in both directions between the movable object 104 and the client device 110. The two-way communication can involve transmitting data from one or more transmitters of the communication system 120B to one or more receivers of the communication system 120A of the client device 110, and vice-versa. In some embodiments, a client device 110 may communicate with an image manager 115 installed on an onboard computing device 112 over a transparent transmission channel of a communication link 106. The transparent transmission channel can be provided through the flight controller of the movable object which allows the data to pass through unchanged (e.g., “transparent”) to the image manager 115. In some embodiments, image manager 115 may utilize a software development kit (SDK), application programming interfaces (APIs), or other interfaces made available by the movable object, onboard computing device, etc. In various embodiments, the image manager may be implemented by one or more processors on movable object 104 (e.g., flight controller 114 or other processors), onboard computing device 112, remote controller 111, client device 110, or other computing device in communication with movable object 104. In some embodiments, image manager 115 may be implemented as an application executing on client device 110, onboard computing device 112, or other computing device in communication with movable object 104.

In some embodiments, an application executing on client device 110 or onboard computing device 112 can provide control data to one or more of the movable object 104, carrier 122, and payload 124 and receive information from one or more of the movable object 104, carrier 122, and payload 124 (e.g., position and/or motion information of the movable object, carrier or payload; data sensed by the payload such as image data captured by a payload camera; and data generated from image data captured by the payload camera). In some instances, control data from the application may include instructions for a target direction to trigger image capture. For example, client device 110 may include an image manager application, such as an image manager client application which may display a live view of one or more target objects in the field of view of one or more image capture devices on the movable object 104. As discussed further below, image manager 115 can be configured to automatically capture images of a target object based on the movement of the target object. The user can specify a movement direction for the target objects through the client application. For example, a gesture-based input may be used to specify the target direction. As shown in FIG. 1, a user may tap and hold at a first position 126 on a touch screen of client device 110 and drag to a second position 128 (e.g., a swipe gesture). A direction of the gesture 130 can be determined by the client application and used as the target direction to trigger image capture when the target objects' apparent movement in the image data is substantially parallel with the target direction. In some embodiments, the user may specify how close to the target direction the primary direction is to be in order to trigger image capture. For example, if the primary direction is within an angular margin (e.g., 5, 10, 15 degrees, 30 degrees, 45 degrees, or other margin), then image capture may be performed. In some embodiments, the angular margin may be configurable by the user.

In some embodiments, the control data may result in a modification of the location and/or orientation of the movable object (e.g., via control of the movement mechanisms 116), or a movement of the payload with respect to the movable object (e.g., via control of the carrier 122). The control data from the application may result in control of the payload, such as control of the operation of a camera or other image capturing device (e.g., taking still or moving pictures, zooming in or out, turning on or off, switching imaging modes, change image resolution, changing focus, changing depth of field, changing exposure time, changing viewing angle or field of view). Although embodiments may be described that include a camera or other image capture device as payload, any payload may be used with embodiments of the present invention. In some embodiments, application 102 may be configured to control a particular payload.

In some instances, the communications from the movable object, carrier and/or payload may include information from one or more sensors (e.g., of the sensing system 118 or of the payload 124) and/or data generated based on the sensing information. The communications may include sensed information from one or more different types of sensors (e.g., GPS sensors, motion sensors, inertial sensor, proximity sensors, or image sensors). Such information may pertain to the position (e.g., location, orientation), movement, or acceleration of the movable object, carrier, and/or payload. Such information from a payload may include data captured by the payload or a sensed state of the payload.

In some embodiments, an onboard computing device 112 can be added to the movable object. The onboard computing device can be powered by the movable object and can include one or more processors, such as CPUs, GPUs, field programmable gate arrays (FPGAs), system on chip (SoC), application-specific integrated circuit (ASIC), or other processors. The onboard computing device can include an operating system (OS), such as Windows 10®, Linux®, Unix®-based operating systems, or other OS. Mission processing can be offloaded from the flight controller 114 to the onboard computing device 112. In various embodiments, the image manager 115 can execute on the onboard computing device 112, client device 110, payload 124, a remote server (not shown), or other computing device.

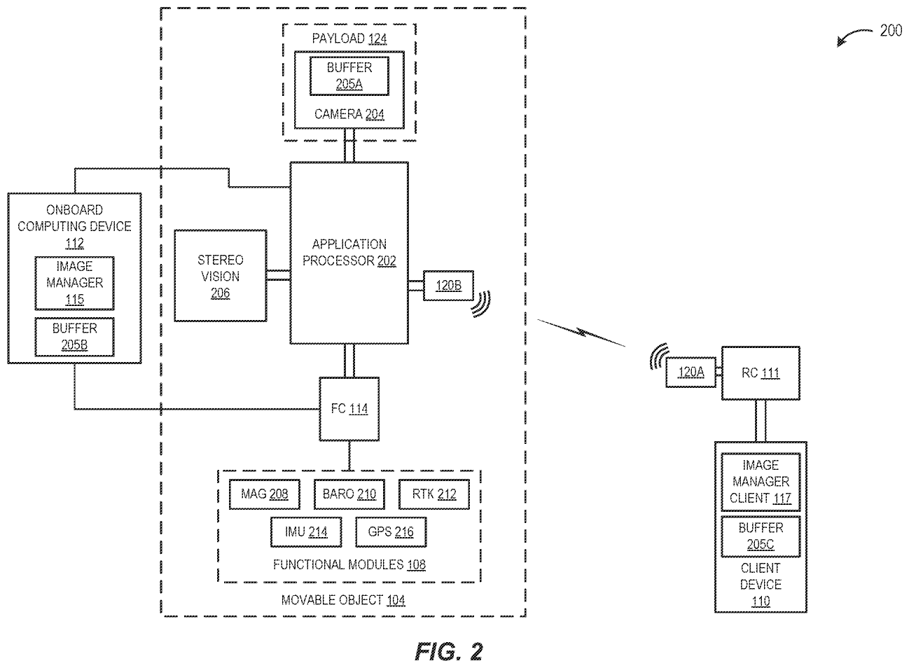

FIG. 2 illustrates an example 200 of a movable object architecture in a movable object environment, in accordance with various embodiments of the present invention. As shown in FIG. 2, a movable object 104 can include an application processor 202 and flight controller 114. The application processor can be connected to the onboard computing device 112 via USB or other interface. The application processor 202 can connect to one or more high bandwidth components, such as camera 204 or other payload 124, stereo vision module 206, and communication system 120B. Additionally, the application processor 202 can connect to the flight controller 114 via UART or other interface. In various embodiments, application processor 202 can include a CPU, GPU, field programmable gate array (FPGA), system on chip (SoC), or other processor(s).

Flight controller 114 can connect to various functional modules 108, such as magnetometer 208, barometer 210, real time kinematic (RTK) module 212, inertial measurement unit (IMU) 214, and positioning system module 216. In some embodiments, communication system 120B can connect to flight controller 114 instead of, or in addition to, application processor 202. In some embodiments, sensor data collected by the one or more functional modules 108 can be passed from the flight controller to the application processor 202 and/or the onboard computing device 112. The image manager 115 can analyze image data captured by camera 204 in view of other sensor data, such as depth information received from stereo vision 206. Additionally, as shown in FIG. 2, image data captured by camera 204 or other image capture devices may be stored in one or more buffers 205, such as a camera buffer 205A, onboard computing device buffer 205B, and/or client device buffer 205C. The buffers may include dedicated memory, disk, or other persistent or volatile storage devices.

In some embodiments, the application processor 202, flight controller 114, and onboard computing device 112 can be implemented as separate devices (e.g., separate processors on separate circuit boards). Alternatively, one or more of the application processor 202, flight controller 114, and onboard computing device can be implemented as a single device, such as an SoC. In various embodiments, onboard computing device 112 may be removable from the movable object.

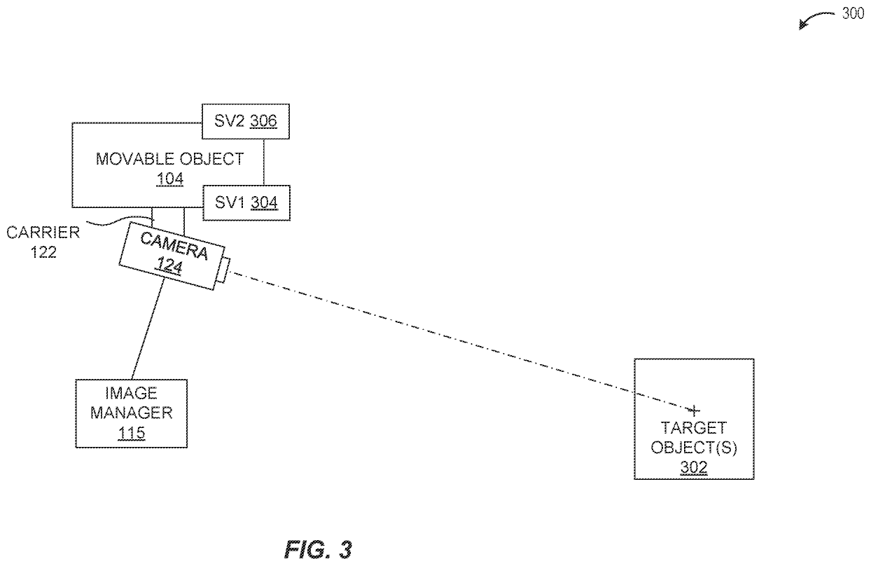

FIG. 3 illustrates an example 300 of image capture of a target object in a movable object environment, in accordance with various embodiments of the present invention. As discussed above, movable object 104 can be configured to capture images of one or more target objects 302 using an image capture device (e.g., camera 124). In some cases, the environment may be an inertial reference frame. The inertial reference frame may be used to describe time and space homogeneously, isotropically, and in a time-independent manner. The inertial reference frame may be established relative to the movable object, and move in accordance with the movable object. Measurements in the inertial reference frame can be converted to measurements in another reference frame (e.g., a global reference frame) by a transformation (e.g., Galilean transformation in Newtonian physics).

In some embodiments, an image capture device (e.g., camera 124) may be a physical image capture device. An image capture device can be configured to detect electromagnetic radiation (e.g., visible, infrared, and/or ultraviolet light) and generate image data based on the detected electromagnetic radiation. An image capture device may include a charge-coupled device (CCD) sensor or a complementary metal-oxide-semiconductor (CMOS) sensor that generates electrical signals in response to wavelengths of light. The resultant electrical signals can be processed to produce image data. The image data generated by an image capture device can include one or more images (e.g., frames), which may be static images (e.g., photographs), dynamic images (e.g., video), or suitable combinations thereof. The image data can be polychromatic (e.g., RGB, CMYK, HSV) or monochromatic (e.g., grayscale, black-and-white, sepia). The image capture device may include a lens configured to direct light onto an image sensor.

In various embodiments, a given image capture device can be characterized by a camera model:

$$[ \begin{matrix}u \\ v \\ 1\end{matrix} ] = K [ R \vert T ] [ \begin{matrix}{x}_{w} \\ {y}_{w} \\ {z}_{w} \\ 1\end{matrix} ]$$

In the camera model [u v 1]^{T} may represent a 2D point in the pixel coordinate system of a given image and [x_{w} y_{w} z_{w} 1]^{T} may represent a 3D point in the world coordinate system representing the real-world location of the point. Matrix K is a camera calibration matrix representing a given camera's intrinsic parameters. For a finite projective camera, the camera calibration matrix may include five intrinsic parameters. R and T are extrinsic parameters which represent transformations from the world coordinate system to the camera coordinate system.

A camera can capture dynamic image data (e.g., video) and/or static images (e.g., photographs), and may switch between capturing dynamic image data and static images. In some embodiments, multiple cameras and/or sensors may be used to capture image data. Although certain embodiments provided herein are described in the context of cameras, it shall be understood that the present disclosure can be applied to any suitable image capture device, and any description herein relating to cameras can also be applied to any suitable image capture device, and any description herein relating to cameras can also be applied to other types of image capture devices. A camera can be used to generate 2D images of a 3D scene (e.g., an environment, one or more objects, etc.). The images generated by the camera can represent the projection of the 3D scene onto a 2D image plane. Accordingly, each point in the 2D image corresponds to a 3D spatial coordinate in the scene. The camera may comprise optical elements (e.g., lens, mirrors, filters, etc.). The camera may capture color images, greyscale image, infrared images, and the like. The camera may be a thermal image capture device when it is configured to capture infrared images.

In some embodiments, the payload may include multiple image capture devices, or an image capture device with multiple lenses and/or image sensors. The movable object 104 may include multiple image capture devices in addition to payload 124, such as stereoscopic vision cameras 304 and 306 which may be capable of taking multiple images substantially simultaneously. The multiple images may aid in determining depth information for target objects 302. For instance, a right image and a left image may be taken and used for stereo-mapping. A depth map may be calculated from a calibrated binocular image. Any number of images may be taken simultaneously to aid in the creation of a 3D scene/virtual environment/model, and/or for depth mapping. The images may be directed in substantially the same direction or may be directed in slightly different directions. In some instances, data from other sensors (e.g., ultrasonic data, LIDAR data, data from any other sensors as described elsewhere herein, or data from external devices) may aid in the creation of a 2D or 3D image or map.

The image capture device may capture an image or a sequence of images at a specific image resolution. In some embodiments, the image resolution may be defined by the number of pixels in an image. In some embodiments, the image resolution may be greater than or equal to about 352×420 pixels, 480×320 pixels, 720×480 pixels, 1280×720 pixels, 1440×1080 pixels, 1920×1080 pixels, 2048×1080 pixels, 3840×2160 pixels, 4096×2160 pixels, 7680×4320 pixels, or 15360×8640 pixels. In some embodiments, the camera may be a 4K camera or a camera with a higher resolution.

The image capture device may capture a sequence of images at a specific capture rate. In some embodiments, the sequence of images may be captured standard video frame rates such as about 24p, 25p, 30p, 48p, 50p, 60p, 72p, 90p, 100p, 120p, 300p, 50i, or 60i. In some embodiments, the sequence of images may be captured at a rate less than or equal to about one image every 0.0001 seconds, 0.0002 seconds, 0.0005 seconds, 0.001 seconds, 0.002 seconds, 0.005 seconds, 0.01 seconds, 0.02 seconds, 0.05 seconds. 0.1 seconds, 0.2 seconds, 0.5 seconds, 1 second, 2 seconds, 5 seconds, or 10 seconds. In some embodiments, the capture rate may change depending on user input and/or external conditions (e.g. rain, snow, wind, unobvious surface texture of environment).

The image capture device may have adjustable parameters. Under differing parameters, different images may be captured by the image capture device while subject to identical external conditions (e.g., location, lighting). The adjustable parameter may comprise exposure (e.g., exposure time, shutter speed, aperture, film speed), gain, gamma, area of interest, binning/subsampling, pixel clock, offset, triggering, ISO, etc. Parameters related to exposure may control the amount of light that reaches an image sensor in the image capture device. For example, shutter speed may control the amount of time light reaches an image sensor and aperture may control the amount of light that reaches the image sensor in a given time. Parameters related to gain may control the amplification of a signal from the optical sensor. ISO may control the level of sensitivity of the camera to available light. Parameters controlling for exposure and gain may be collectively considered and be referred to herein as EXPO.

The payload may include one or more types of sensors. Some examples of types of sensors may include location sensors (e.g., global positioning system (GPS) sensors, mobile device transmitters enabling location triangulation), vision sensors (e.g., image capture devices capable of detecting visible, infrared, or ultraviolet light, such as cameras), proximity or range sensors (e.g., ultrasonic sensors, lidar, time-of-flight or depth cameras), inertial sensors (e.g., accelerometers, gyroscopes, and/or gravity detection sensors, which may form inertial measurement units (IMUs)), altitude sensors, attitude sensors (e.g., compasses), pressure sensors (e.g., barometers), temperature sensors, humidity sensors, vibration sensors, audio sensors (e.g., microphones), and/or field sensors (e.g., magnetometers, electromagnetic sensors, radio sensors).

The payload may include one or more devices capable of emitting a signal into an environment. For instance, the payload may include an emitter along an electromagnetic spectrum (e.g., visible light emitter, ultraviolet emitter, infrared emitter). The payload may include a laser or any other type of electromagnetic emitter. The payload may emit one or more vibrations, such as ultrasonic signals. The payload may emit audible sounds (e.g., from a speaker). The payload may emit wireless signals, such as radio signals or other types of signals.

As described above, an image manager 115, which may or may not be part of a camera, may be included in movable object 104, payload 124, a client device, or other computing device capable of receiving image data from payload 124. For example, the image manager 115 may be configured to receive and analyze image data collected by the payload (e.g., by an image capture device). The image data may include images of the target object 302 captured by the image capture device. The images of the target object may be depicted within a plurality of image frames. For example, a first image frame may comprise a first image of the target object, and a second image frame may comprise a second image of the target object. The first and second images of the target object may be captured at different points in time.

The image manager may be configured to analyze the first image frame and the second image frame to determine a change in one or more features between the first image of the target object and the second image of the target object. The one or more features may be associated with the images of the target object. The change in the one or more features may comprise a change in size and/or position of the one or more features. The one or more features may also be associated with a tracking indicator. The images of the target object may be annotated by the tracking indicator, to distinguish the target object from other non-tracked objects within the image frames. The tracking indicator may be a box, a circle, or any other geometric shape surrounding the images of the target object within the image frames.

In some embodiments, the tracking indicator may be a bounding box. The bounding box may be configured to substantially surround the first/second images of the target object within the first/second image frames. The bounding box may have a regular shape or an irregular shape. For example, the bounding box may be a circle, an ellipse, a polygon, or any other geometric shape.

The one or more features may correspond to a geometrical and/or positional characteristic(s) of a bounding box. The geometrical characteristic(s) of the bounding box may, for example, correspond to a size of the bounding box within an image frame. The positional characteristic of the bounding box may correspond to a position of the bounding box within an image frame. The size and/or position of the bounding box may change as the spatial disposition between the target object and the movable object changes. The change in spatial disposition may include a change in distance and/or orientation between the target object and the movable object.

In some embodiments, the image manager may be configured to determine the change in size and/or position of the bounding box between the first image frame and the second image frame. As discussed further below, the change in position of the bounding box may be used together with depth information collected for the one or more target objects to trigger an image capture device to capture images of the target object and/or to analyze previously captured image data to select one or more images of the target object based on the movement characteristics of the target objects.

In some embodiments, the image data may be captured by payload 124 and analyzed to identify one or more people using facial recognition. In this example, the movable object can capture image data of the one or more people as the target objects. An initial bounding box or other tracking indicator can be generated for each face identified in the image data. The initial bounding box can be expanded to include the bodies of each person using body recognition techniques, such that a single bounding box includes all, or substantially all, of the identified people in the image data. In some embodiments, the movable object may identify a person who has registered their face with the image manager previously (e.g., by uploading an image of their face using the movable object, client device, etc.). Once the bounding box has been generated, it can be tracked from frame to frame and the movement characteristics of the bounding box can be determined. As used herein, the portion of image data within the bounding box may be referred to as a region of interest (ROI).

Additionally, or alternatively, a bounding box may be generated based on one or more features identified in the image data that are associated with the target objects. Each feature may include one or more feature points which can be a portion of an image (e.g., an edge, corner, interest point, blob, ridge, etc.) that is distinguishable from the remaining portions of the image and/or other feature points in the image. Optionally, a feature point may be relatively invariant to transformations of the imaged object (e.g., translation, rotation, scaling) and/or changes in the characteristics of the image (e.g., brightness, exposure). A feature point may be detected in portions of an image that is rich in terms of informational content (e.g., significant 2D texture). A feature point may be detected in portions of an image that are stable under perturbations (e.g., when varying illumination and brightness of an image).

Feature points can be detected using various algorithms (e.g., texture detection algorithm) which may extract one or more feature points from image data. The algorithms may additionally make various calculations regarding the feature points. For example, the algorithms may calculate a total number of feature points, or “feature point number.” The algorithms may also calculate a distribution of feature points. For example, the feature points may be widely distributed within an image (e.g., image data) or a subsection of the image. For example, the feature points may be narrowly distributed within an image (e.g., image data) or a subsection of the image. The algorithms may also calculate a quality of the feature points. In some instances, the quality of feature points may be determined or evaluated based on a value calculated by algorithms mentioned herein (e.g., FAST, Corner detector, Harris, etc.).

The algorithm may be an edge detection algorithm, a corner detection algorithm, a blob detection algorithm, or a ridge detection algorithm. In some embodiments, the corner detection algorithm may be a “Features from accelerated segment test” (FAST). In some embodiments, the feature detector may extract feature points and make calculations regarding feature points using FAST. In some embodiments, the feature detector can be a Canny edge detector, Sobel operator, Harris & Stephens/Plessy/Shi-Tomasi corner detection algorithm, the SUSAN corner detector, Level curve curvature approach, Laplacian of Gaussian, Difference of Gaussians, Determinant of Hessian, MSER, PCBR, or Grey-level blobs, ORB, FREAK, or suitable combinations thereof.

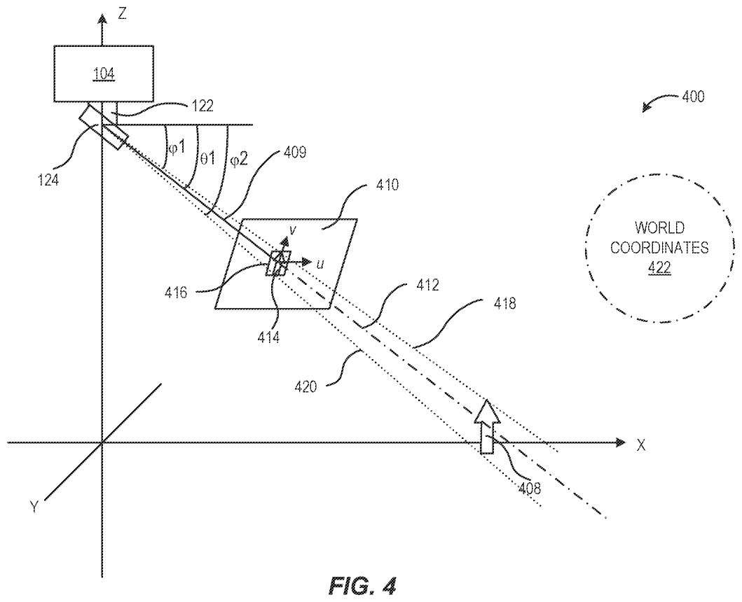

FIG. 4 illustrates an example of projection of a representation of a target object in a world coordinate system to a pixel coordinate system, in accordance with various embodiments of the present invention. As shown in FIG. 4, the imaging of the target object may be approximated using an aperture imaging model, which assumes that a light ray from a point on the target object in a three-dimensional space can be projected onto the image plane 410 to form an image point. The image capture device may comprise a mirror (or lens). An optical axis 412 may pass through a center of the mirror and a center of the image plane 410. A distance between the mirror center and the image center may be substantially equal to a focal length 409 of the image capture device. For purposes of illustration, the image plane 410 may be depicted at the focal length distance along the optical axis 412, between the image capture device and the target object. Although embodiments are generally described with respect to transforming world coordinates to pixel coordinates, embodiments are generally applicable to transformations from the world coordinate system to alternative reference systems.

When the movable object 104 is at a first position relative to the target object, as shown in FIG. 4, the image capture device 124 may be rotated by an angle θ₁ clockwise about the Y-axis of world coordinates 422, which results in a downward pitch of the image capture device relative to the movable object. Accordingly, an optical axis 412 extending from the mirror center of the image capture device may also rotate by the same angle θ1 clockwise about the Y-axis. The optical axis 412 may pass through the center of a first image plane 410 located at the focal length distance 409. At this position, the image capture device may be configured to capture a first image 414 of the target object onto the first image plane 410. Points on the first image plane 410 may be represented by a set of (u, v) image coordinates. A first bounding box 416 may be configured to substantially surround the first image 414 of the target object. The bounding box can be used to enclose one or more points of interest (for example, enclosing the image of the target object). The use of the bounding box can simplify tracking of the target object. For example, complex geometrical shapes may be enclosed within the bounding box and tracked using the bounding box, which eliminates the need to monitor discrete changes in the size/shape/position of the complex geometrical shapes. The bounding box may be configured to vary in size and/or position as the image of the target object changes from one image frame to the next. In some cases, a shape of the bounding box may vary between image frames (e.g., changing from a square box to a circle, or vice versa, or between any shapes).

The target object 408 may have a top target point (xₜ, yₜ, zₜ) and a bottom target point (x_{b}, y_{b}, z_{b}) in world coordinates 422, which may be projected onto the first image plane 410 as a top image point (uₜ, vₜ) and a bottom image point (u_{b}, v_{b}) respectively in the first target image 414. An optical ray 418 may pass through the mirror center of the image capture device, the top image point on the first image plane 410-1, and the top target point on the target object 408. The optical ray 418 may have an angle ϕ₁ clockwise about the Y-axis of the world coordinates 422. Similarly, another optical ray 420-1 may pass through the mirror center of the image capture device, the bottom image point on the first image plane 410, and the bottom target point on the target object 408. The optical ray 420 may have an angle ϕ₂ clockwise about the Y-axis of the world coordinates 422. As shown in FIG. 4, ϕ₂ (bottom target/image point)>θ₁ (center of image plane)>ϕ₁ (top target/image point) when the movable object is at the shown position relative to the target object.

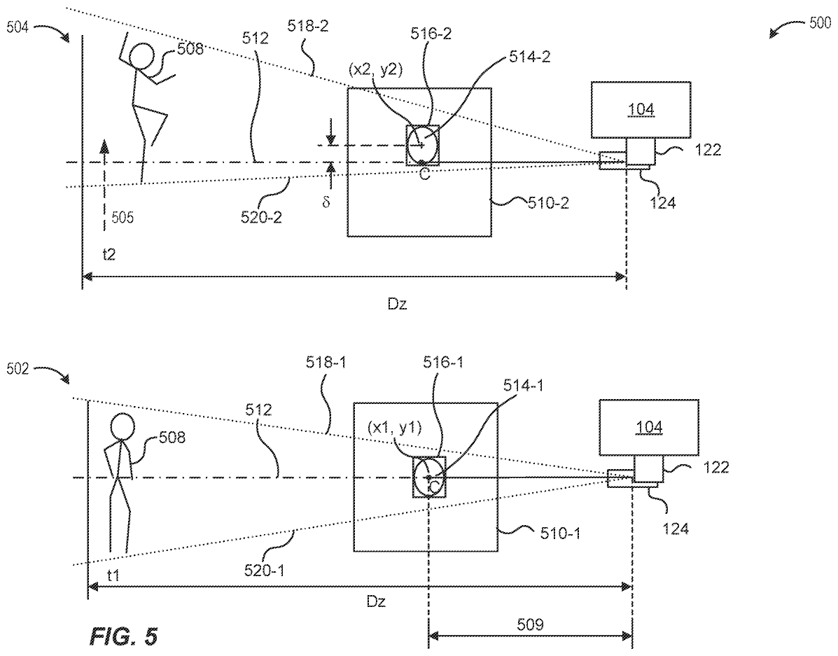

FIG. 5 illustrates target object tracking, in accordance with various embodiments of the present invention. At 502, a movable object 104 carrying an image capture device 124 may be in front of a target object 508 at time t1. An optical axis 512 may extend from a mirror center of the image capture device to a center portion of the target object. The optical axis 512 may pass through the center of a first image plane 510-1 located at a focal length distance 509 from the mirror center of the image capture device.

The image capture device may be configured to capture a first image 514-1 of the target object onto the first image plane 510-1. Points on the first image plane 510-1 may be represented by a set of (u, v) image coordinates, as discussed above. A first bounding box 516-1 may be configured to substantially surround the first image 514-1 of the target object. The bounding box may be configured to vary in size and/or position when the target object moves relative to the movable object.

The size and position of the first bounding box may be defined by optical rays 518-1 and 520-1. The optical ray 518-1 may pass through the mirror center of the image capture device, a first image point on the first image plane 510-1, and a first target point on the target object 508. The optical ray 520-1 may pass through the mirror center of the image capture device, a second image point on the first image plane 510-1, and a second target point on the target object 508. At 502, the first bounding box may be located substantially at a center portion of the first image plane 510-1. For example, a set of center coordinates (x1, y1) of the first bounding box may coincide with a center C of the first image plane. In some alternative embodiments, the first bounding box may be located substantially away from the center portion of the first image plane 510-1, and that the center coordinates (x1, y1) of the first bounding box may not coincide with the center C of the first image plane.

At 504, the target object may have moved to a different position relative to the movable object at time t2. For example, the target object may have moved along the Z-axis (in this example, the target object, a person, may have jumped 505 up into the air leading to a vertical displacement relative to the position shown in 502). Accordingly, the optical axis 512 may no longer extend from the mirror center of the image capture device to the center portion of the target object at time t2.

The image capture device may be configured to capture a second image 514-2 of the target object onto a second image plane 510-2. Points on the second image plane 510-2 may also be represented by a set of (u, v) image coordinates. A second bounding box 516-2 may be configured to substantially surround the second image 514-2 of the target object. The size and position of the second bounding box may be defined by optical rays 518-2 and 520-2. The optical ray 518-2 may pass through the mirror center of the image capture device, a first image point on the second image plane 510-2, and the first target point on the target object 808. The optical ray 520-2 may pass through the mirror center of the image capture device, a second image point on the second image plane 510-2, and the second target point on the target object 508. Unlike at 502, the second bounding box in 504 may not be located at a center portion of the second image plane 510-2. For example, a set of center coordinates (x2, y2) of the second bounding box may not coincide with a center C of the second image plane.

In some embodiments, a distance the target object has moved can be estimated using an optical flow method, such as the Lucas-Kanade method, which may be represented by the following equation:

$$u = {argmin}_{{u}^{′}} {\sum }_{x} {[ {I}_{t + 1} ( x + {u}^{′} ) - T ( x ) ]}^{2}$$

Iₜ may represent the original reference image at time t. T indicates the template to be matched, in the described examples T may represent the ROI indicated by the bounding box and x is the center of the template. A gradient descent method may be used to determine the time at t+1. In image Iₜ+1, the portion of the image data that most closely matches T and its displacement across the two images is recorded as a matrix u. For computational convenience, the variation Au (representing the displacement of T between the two images) may be solved as follows:

$$Δ u = {argmin}_{{u}^{′}} {\sum }_{x} {[ {I}_{t + 1} ( x + u + Δ {u}^{′} ) - T ( x ) ]}^{2}$$

This may be further optimized by calculating the dense optical flow vector by the Dense Inverse Search (DIS) algorithm.

$$Δ u = {argmin}_{{u}^{′}} {\sum }_{x} {[ T ( x - Δ u ) - {I}_{t + 1} ( x + u ) ]}^{2}$$

Using the Dense Inverse search, an initial flow field can be set U_{θss+1}←0, and for s=θss to θsf, a uniform grid of Nₛ patches can be created. Displacements from Uₛ₊₁ can be initialized for i=1 to Nₛ. An inverse search can be performed for patch i and a dense flow field Uₛ can be computed followed by variational refinement of U. Accordingly, optical flow vectors may be calculated for each pixel in a ROI identified by a bounding box between two or more image frames. In some embodiments, a change of the bounding box in the image data may be used to subsequently control movement of the carrier (e.g., gimbal or other mount) and/or the movable object to track the ROI. For example, the movable object may change position, or the carrier may change its orientation, to keep the ROI at or near a predetermined position (e.g., center), and/or to keep the ROI at or near a predetermined size within the images. For example, a distance between optical center and the target object may be controlled via movement of the camera and/or UAV, or parameters of the camera (e.g., zoom) so as to maintain the bounding box of the target appears with a certain size across the images.

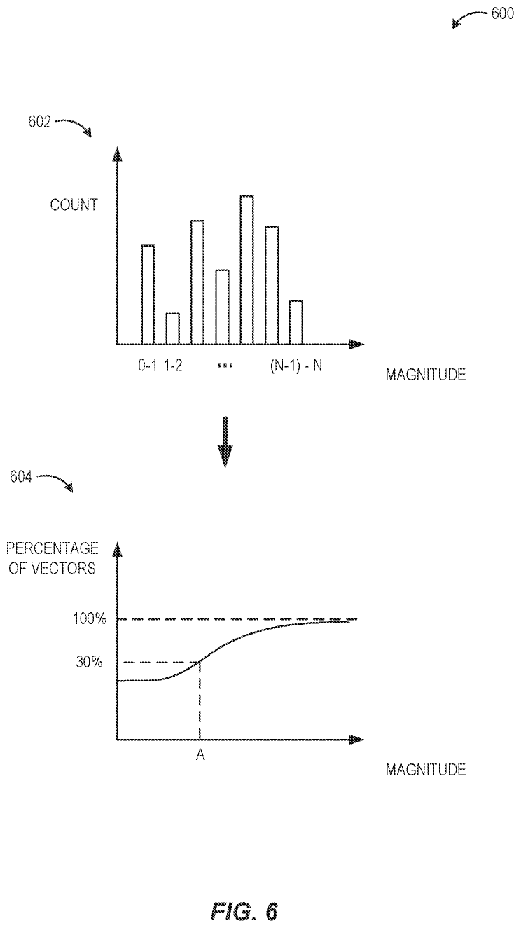

FIG. 6 illustrates determining a movement magnitude characteristic of a region of interest, in accordance with various embodiments of the present invention. As discussed above, an optical flow vector can be determined between each pair of frames in the image data. The optical flow vector may represent a displacement of an ROI from one frame to the next (e.g., a vector from a center point of a bounding box in a first frame, to a center point of a bounding box of a second frame, or vectors for each pixel in the bounding box from one frame to the next). The movement of a given ROI can include a movement magnitude characteristic and a movement direction characteristic. In some embodiments, the movement magnitude characteristic may be a length of the apparent movement represented by the optical flow vector as measured in, e.g., pixels in the image coordinate system, meters in the world coordinate system, or other units if measured in other coordinate systems. The movement characteristics for a given ROI can be determined by separately evaluating and accumulating the movement magnitude and movement direction characteristics for the optical flow vectors determined for the ROI between two or more frames.

As shown in FIG. 6, at 602, a histogram can be generated which represents all, or a portion, of the optical flow vectors determined for the ROI in the image data. Magnitudes of each vector can be calculated. Each bin of the histogram can represent vectors having a particular magnitude or range of magnitudes. For example, each vector having a magnitude of 0-1 pixels can be added to the first bin, the second bin can include each vector having a magnitude of 0-2 pixels, and so on until the next to last bin including vector components having a magnitude of N−1 pixels and the last bin having the largest magnitude vectors N. The bins shown in FIG. 6 are examples, alternative groupings of magnitudes may also be used. The height of each histogram bar can represent the number of vector of a given magnitude or range of magnitudes.

As shown at 604, once the vectors have been sorted, another graph can be used to represent the percentage of vectors having magnitudes less than or equal to a given magnitude A. In this example, 30% of the total number of optical flow vectors have a magnitude less than or equal to magnitude A. As discussed further below, magnitude thresholds may be determined using depth information for the target objects represented in the ROI. When the percentage of vectors exceeding the threshold magnitude is greater than a threshold value (e.g., 30% or other user-configurable value) then the ROI can be considered to be moving at greater than the threshold magnitude value.

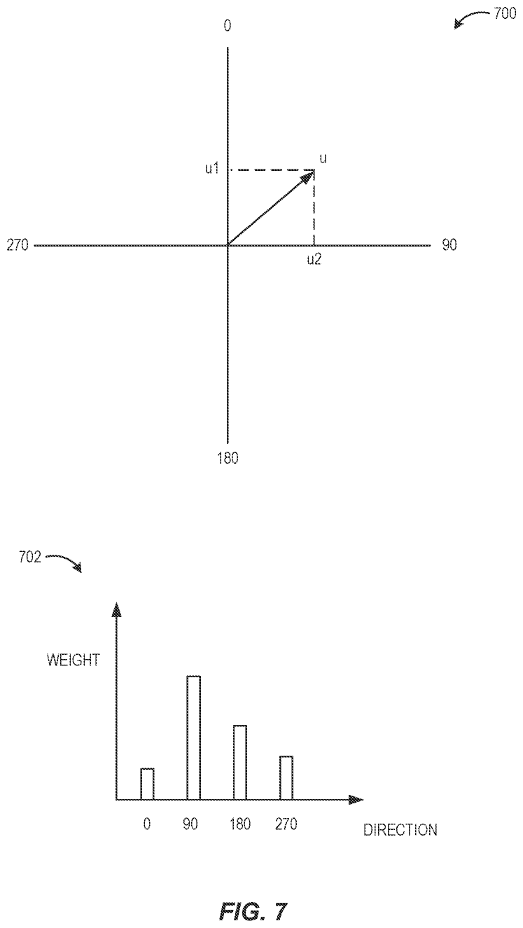

FIG. 7 illustrates determining a movement direction characteristic of a region of interest, in accordance with various embodiments of the present invention. In addition to evaluating the movement magnitude characteristic, the movement direction characteristic may also be categorized. As shown in FIG. 7, an optical flow vector u can be projected onto the up direction (which, as shown, may be taken to be 0 degrees), down (180 degrees from the up direction), left (270 degrees from the up direction), and right (90 degrees from the up direction) directions. These four directions shown in FIG. 7 are exemplary, and alternative directions, such as a rotation of these four directions, or more or fewer directions, may also be used). For example, directions may be evenly spaced (e.g., every 30 degrees, 40 degrees, 60 degrees, 90 degrees or 120 degrees, etc.) or unevenly spaced in a plurality of directions, etc. Additionally, the choice of direction which may be set to 0 may also vary depending on implementation.

Vector u can be decomposed into components u₁ and u₂. A weight V for each component can be calculated as discussed above. For example, each vector u can be decomposed into two components u₁ and u₂, representing each dimensional component of the vector. A weight of each component of a vector can be calculated according to: Vᵤ₁=magᵤ*u₁/(u₁+u₂) and Vᵤ₂=magᵤ*u₂/(u₁+u₂). For example, if the magnitude of a vector is 5, u₁ is 3, and u₂ is 3 (e.g., a simple triangle with edge lengths of 3, 4, 5), then the weight of u₁ is 5*3/(3+4)=2.14 and similarly the weight of u₂ is 5*4(3+4)=2.86. In some embodiments, each vector component can be normalized based on vector length. At 702, a histogram can be generated having four bins, one for each direction. The weights of each vector component (u₁, u₂) can be accumulated into each bin based on the associated direction with each component, such that the height of each histogram bar represents a total weight of vector components associated with a given direction. The movement direction of the ROI may then be estimated based on the bin having the highest weight.

The movement direction may represent the “primary” direction of movement of the ROI. Apparent movement in an image may occur in multiple directions. For example, an ROI may include multiple objects that may move in different directions. The primary direction can be determined by analyzing the direction of each vector component and may represent the direction determined to have the highest cumulative weight. For example, in histogram 702, the movement direction characteristic can be estimated to be toward the right. In some embodiments, if more than one bin has the highest weight, then the direction corresponding to each bin can be identified as the primary direction associated with the movement. If any of those directions correspond to the target direction, then image capture may be triggered. In some embodiments, if more than one bin has the highest weight, then no direction may be identified as the primary direction and image capture may not be triggered.

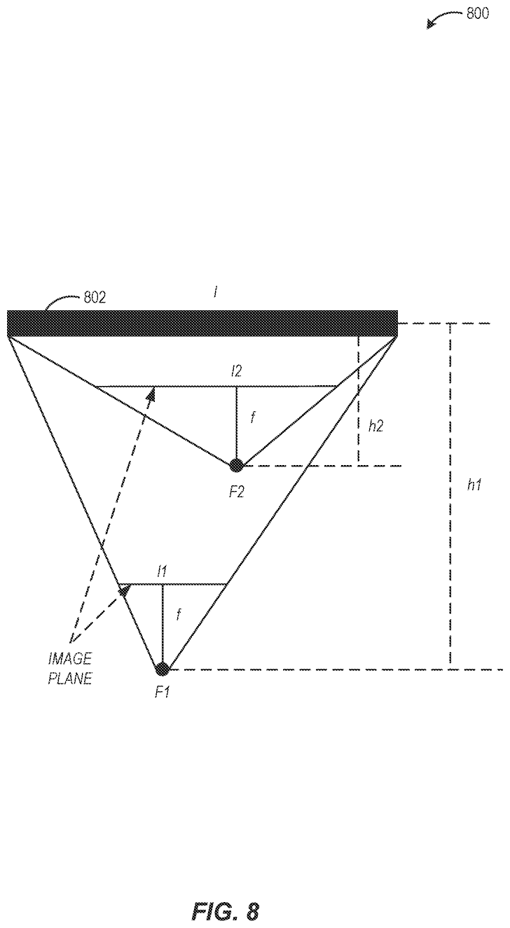

FIG. 8 illustrates an example of determining a depth of a target object, in accordance with various embodiments of the present invention. FIG. 8 illustrates the calculation of an object depth of a feature point based on a scale factor between corresponding sizes of a real-world object 802 shown in two images that are captured at different positions F1 and F2, in accordance with some embodiments.

The object depth of a feature point is a distance between a real-world object represented by the feature point in an image and the optical center of the camera that captured the image. In general, the object depth is relative to the real-world position of the camera at the time that the image was captured. In the present disclosure, unless otherwise specified, object depth of a feature point is calculated to be relative to the current position of the movable object.

In FIG. 8, the respective locations of F1 and F2 represent the respective locations of the movable object (or more specifically, the locations of the optical center of the onboard camera) when the images (e.g., the base image and the current image) are captured. The focal length of the camera is represented by f. The actual lateral dimension (e.g., the x-dimension) of an imaged object is represented by l. The images of the object show the lateral dimensions to be l₁ and l₂, respectively, in the base image and in the current image. The actual distance from the optical center of the camera to the object is h₁ when the base image was captured, and is h₂ when the current image is captured. The object depth of the image feature that corresponds to the object is h₁ relative to the camera at F1, and is h₂ relative to the camera at F2.

As shown in FIG. 8, in accordance with the principle of similarity,

$$\frac{{l}_{1}}{f} = \frac{l}{{h}_{1}} , \frac{{l}_{2}}{f} = \frac{l}{{h}_{2}} , \to \frac{{l}_{2}}{{l}_{1}} = \frac{{h}_{1}}{{h}_{2}} .$$

Since the scale factor between the corresponding patches for the feature point is

$${S}_{1 \to 2} = \frac{{h}_{2}}{{h}_{1}} ,$$

the change in position of the movable object between the capture of the base image and the capture of the current image is Δh=h₁=h₂, which can be obtained from the movable object's navigation system log or calculated based on the speed of the movable object and the time between the capture of the base image and the capture of the current image. Based on the correlated equations:

$$\frac{{l}_{2}}{{l}_{1}} = \frac{{h}_{1}}{{h}_{2}} and Δ h = {h}_{1} = {h}_{2} .$$

the values of h₁ and h₂ can be calculated. The value of h₁ is the object depth of the image feature representing the object in the base image, and the value of h₂ is the object depth of the image feature representing the object in the current image. Correspondingly, the distance between the object and the camera is h₁ when the base image was taken and is h₂ when the current image was taken.

In some scenarios, particularly when a feature point that is being tracked across the images corresponds to an edge of a real-world object, the depth estimation is not very accurate because the assumption that the whole pixel patch surrounding the feature point has the same depth is incorrect. In some embodiments, in order to improve the accuracy of the object depth estimation for a respective feature point in a current image, the object depth estimation is performed for multiple images between the base image and the current image for the respective feature point that exists in these multiple images. The object depth values obtained for these multiple images are filtered (e.g., by a Kalman filter, or running average) to obtain an optimized, more accurate estimate.

After the object depth of a feature point is obtained based on the process described above, three dimensional coordinates of the feature point are determined in a coordinate system centered at the onboard camera. Suppose that a feature point has an x-y position of (u, v) in the current image, and an object depth of h in the current image, the three-dimensional coordinates of an object that corresponds to the feature point are (x, y, z) in a real-world coordinate system centered at the onboard camera (or more generally, at the movable object) are calculated as follows: z=h; x=(u−u₀)*z/f; y=(v−v₀)*z/f, where (u₀, v₀) are the x-y coordinates of the optical center of the camera when the image was captured, e.g., based on an external reference frame.

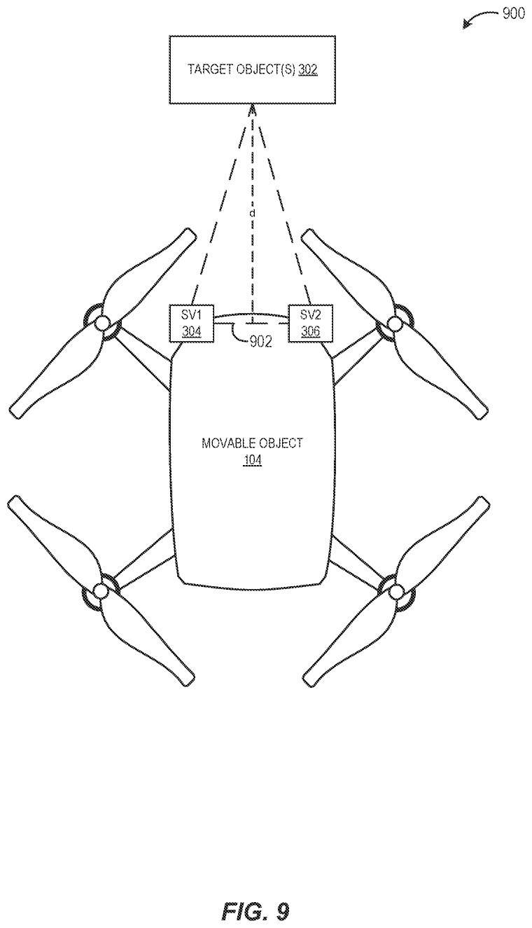

FIG. 9 illustrates an example 900 of determining a depth of a target object, in accordance with various embodiments of the present invention. As shown in FIG. 9, an alternative way of determining depth information of a target object is through a stereoscopic vision system. For example, movable object 104 may include multiple stereoscopic cameras SV1 304 and SV2 306. These cameras may be located on the movable object at known locations relative to one another. For example, where two stereoscopic cameras are in use, the distance between the two cameras 902 is known. The approximate depth (e.g., distance to the target objects 302) may then be determined through triangulation. Although FIGS. 8 and 9 each show a different technique of determining depth information for one or more target objects, additional techniques may also be used. For example, movable object 104 may include a rangefinder, laser, LiDAR system, acoustic locating system, or other sensors capable of determining an approximate distance between the movable object and the target objects.

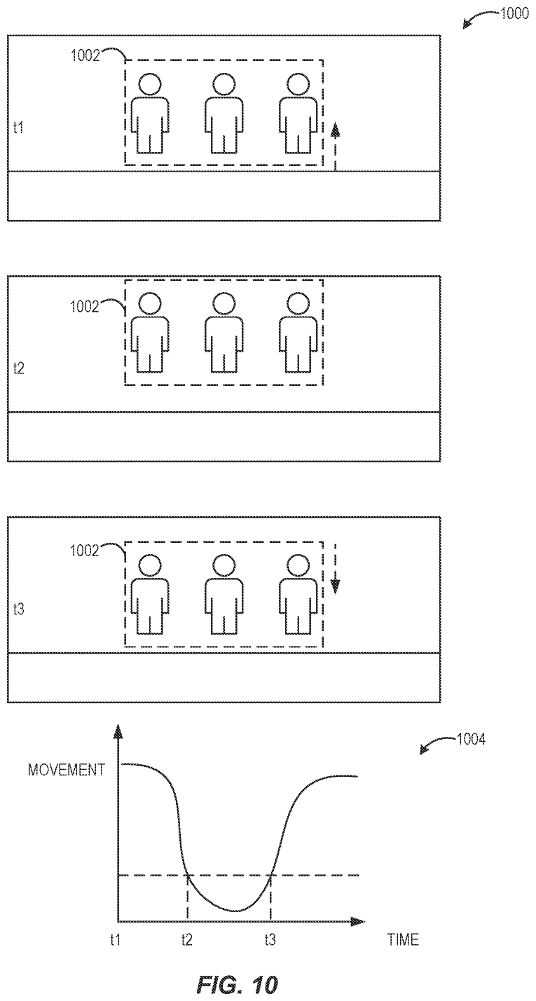

FIG. 10 illustrates an example of determining a movement tendency of a bounding box using depth-based movement thresholds, in accordance with various embodiments of the present invention. As discussed, the depth information for the target objects can be used to determine a magnitude of the movement of the region of interest in the pixel coordinate system. Without depth information (e.g., an approximate physical distance to the target objects represented in the region of interest), the magnitude of the movement of the target objects cannot be accurately determined based on the optical flow of a 2D representation. For example, an object close to the image capture device may move a small amount in the world coordinate system but the movement may appear large in the pixel coordinate system, likewise an object far from the image capture device may move a large amount in the world coordinate system but may only appear to be a small movement in the pixel coordinate system.

Accordingly, in various embodiments, the depth information can be used to determine a movement threshold and a static threshold. These thresholds may be used to determine whether the target objects in the ROI in the image data are moving or are static. In various embodiments, the movement speeds may be user configurable (e.g., the user may provide a movement speed and a static speed which are then converted into displacements). The values used herein are for simplicity of explanation, embodiments may be used with various values defining movement depending on the types of target objects being imaged, the expected movement of the target objects, etc. Based on the cameral calibration parameter K, and the inertial measurement system of the movable object, one may get R, T through the following model:

$$[ \begin{matrix}u \\ v \\ 1\end{matrix} ] = K [ R \vert T ] [ \begin{matrix}{x}_{w} \\ {y}_{w} \\ {z}_{w} \\ 1\end{matrix} ]$$

R and T are extrinsic parameters which represent transformations from the world coordinate system to the camera coordinate system. Values may be selected to determine movement (e.g., over 0.3 m/s is considered movement, while below 0.15 m/s is considered static), thus based on 30 frames per second frame rate, between two adjacent frames, a displacement of 1 cm is considered movement, while displacement of 5 mm is considered standstill. If y_{w} and z_{w} are set to zero, and x_{w} is set to 1 cm, a 2D vector is obtained. The magnitude of the 2D vector corresponds to the movement threshold Tₘ. Likewise, if y_{w} and z_{w} are set to zero, and x_{w} is set to 5 mm, a 2D vector is obtained. The magnitude of this vector corresponds to the static threshold T. As discussed, movement at different depths in the world coordinate system may result in different apparent movements in the image coordinate system. Accordingly, the depth information enables thresholds for the apparent movement of the ROI in the image data to be determined for the objects represented in the ROI at their actual depth.

As shown in FIG. 10, the movement thresholds can be used to determine when to automatically capture images of the target objects. For example, the target objects may include three people. As discussed above, a bounding box 1002 can be generated that includes the three people. The target direction of the bounding box may be set to up. As such, the image capture device is to capture image data when the bounding box is at its greatest magnitude in the upward direction. As the bounding box includes a representation of people, the path the people may take in a jump is upward motion, no motion (e.g., static) at the top of the jump, followed by downward motion. The magnitude of the displacement is highest at the top of the jump, when movement stops. Accordingly, three times can be recorded: a first time t1 when movement above the movement threshold is detected, time two t2, when movement drops below the static threshold, and time 3 t3, when movement again is detected above the movement threshold.

This movement is depicted approximately at 1004. Multiple time points are depicted in FIG. 10. At t1, the ROI 1002 has been determined to be moving upwards at or greater than the movement threshold. For example, the three people depicted in the ROI have jumped upward. At t2, movement has slowed (or stopped) and has fallen below the static threshold. For example, the three people jumping have at least approached the peak of their jump. As such, their movement has slowed. At t3, the ROI begins moving downward and exceeds the movement threshold. For example, the jump has peaked, and the people are falling back downward. These points in time may be used to select images for further analysis, based on the movement thresholds. In some embodiments, movement can be determined based on the total number of frames determined to show movement of the bounding box greater than the threshold. For example, when the number of frames in which the present optical flow vector magnitude is greater than Tm is more than 10% of the total number of frames, the ROI in the bounding box is considered moving. This time may be recorded as time t1. When the number of frames in which the present optical flow vector magnitude is less than Ts is more than 90% of the total number of frames, then the ROI is considered to be static. This time may be recorded as time t2. Additionally, when the number of frames in which the present optical flow vector magnitude is again greater than Tm is more than 10% of the total number of frames, then the ROI considered moving again. This time may be recorded as time t3. The frame thresholds discussed above (e.g., the greater than 90% or less than 10% thresholds) may be user configurable or set based on available buffer space and/or size (e.g., based on how many image frames a buffer can store). In some embodiments, the frame thresholds may be provided by a user through a user interface. Embodiments are described with respect to determining points in time based on the movement thresholds. However, in various embodiments, particular frames may be identified in addition to, or instead of, points in time, based on the movement thresholds.

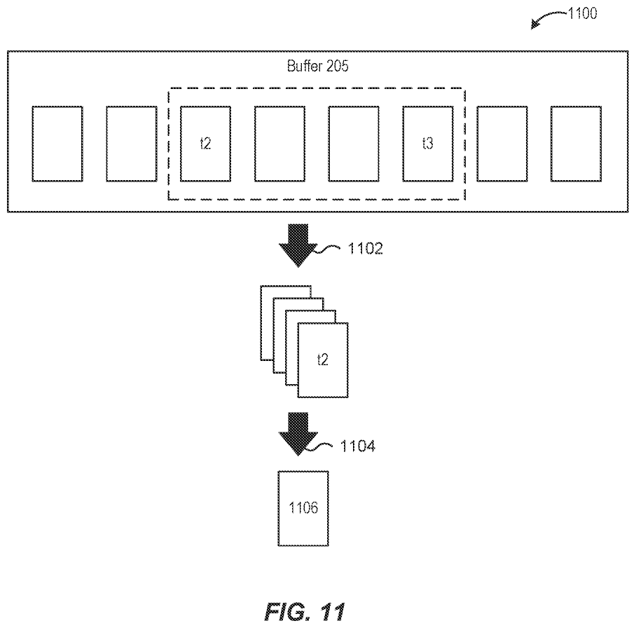

FIG. 11 illustrates an example of selecting image data based on the movement tendency of the bounding box, in accordance with various embodiments of the present invention. As shown in FIG. 11, a buffer 205, cache, or other data structure may include a plurality of images (e.g., frames) from the image data. This portion of the image data may have been captured based on the detected movement (e.g., upon detecting movement at t1, the image data is captured and stored in the buffer) or the image data may be captured and later analyzed. In some embodiments, the image data may include a series of live view images or a video sequence. At 1102, frames captured at around time t2 may be extracted from the buffer 205. In some embodiments, a range of frames around a given time point may be selected. The range of frames may be selected based on a configurable temporal range or ranges around the point in time (e.g., 20 milliseconds before and 30 milliseconds after t2, etc.). At 1104, this subset of frames close in time to t2 may be further filtered to identify image 1106 which represents a “best” image of the ROI in movement. In various embodiments, the subset of frames close in time to t2 may be scored based on various image processing techniques. For example, facial recognition may be used to determine whether individuals' eyes are shut and assign a lower score if they are. In some embodiments, a score may be generated using a trained machine learning model. Similarly, a sharpness of each frame may be evaluated and scored based on the sharpness of the image. In some embodiments, sharpness may be estimated using the peak focusing principle. For example, the Tenengrad gradient method uses the Sobel operator to calculate the horizontal and vertical gradients. The higher the gradient value in the same scene, the clearer the image. Additionally, or alternatively, other techniques may be used to determine a sharpness of a given image, such as Laplacian gradient methods, variance methods, and other methods. The scores for one or more of the image characteristics may be combined (e g, summed, weighted summed, or other combination) to determine an image score. The image with the highest score may then be selected.

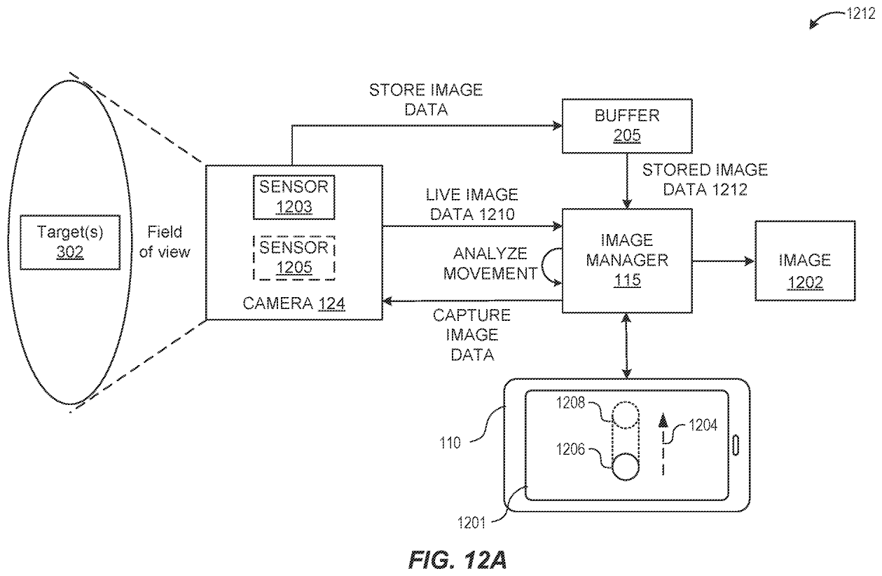

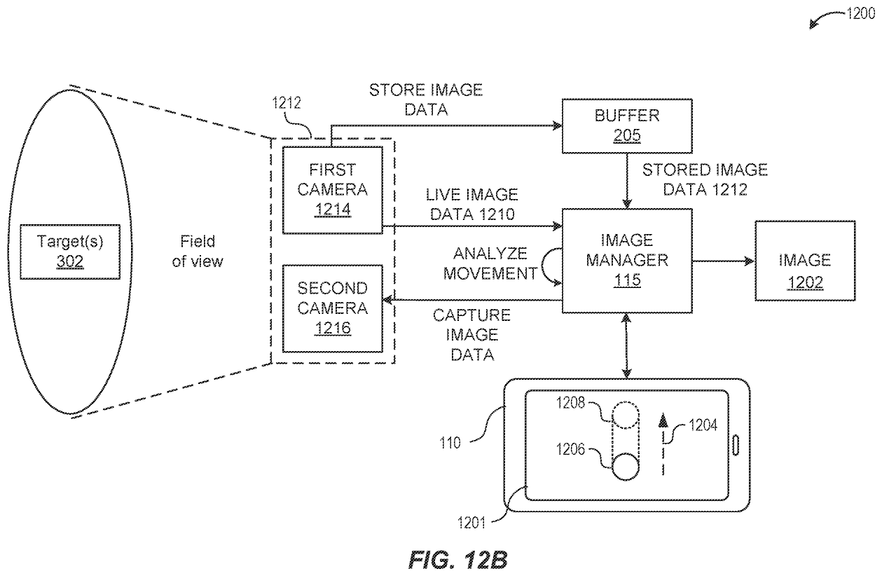

FIGS. 12A and 12B illustrate example systems for automatic image capture based on movement, in accordance with various embodiments of the present invention. As shown in FIG. 12A, a camera 124 can be used to capture image data of one or more targets 302 within the camera's field of view. In various embodiments, a client device 110 can include an image manager user interface 1201. The image manager user interface may be displayed on a touchscreen or other physical interface of client device 110. In some embodiments, image manager UI 1201 can be provided by an image manager client application executing on client device 110 and in communication with image manager 115. In some embodiments, image manager UI 1201 can be a web-based application accessible through a web browser executing on client device 110.

Image manager UI 1201 can display a live view of the targets 302 captured by camera 124. For example, image data captured by camera 124 can be streamed to image manager 115 and passed to image manager UI 1201. Additionally, or alternatively, client device 110 may connect to camera 124 over a wireless connection to the movable object (e.g., via a remote controller, a flight controller, or onboard computing device as discussed above with respect to FIG. 1). The image data may be streamed to a display buffer of client device 110 from which the image data is rendered on the client device's user interface. As discussed above, the user can provide a target direction 1204 via the client device's user interface. When the targets are determined to be moving in a direction substantially parallel to the target direction, camera 124 can capture image data and store the image data to a buffer 205, persistent memory store, or other storage location.

The user may provide the target direction 1204 in a variety of ways, depending on the particular user interface in user. For example, a user may provide a gesture-based input through a touchscreen. In such example, the user may tap and hold on a first location 1206 on the touchscreen, and then while maintaining contact with the touchscreen move to a second location 1208 (e.g., a swipe gesture). A line between the two points may then be determined and the direction of that line in the pixel coordinate system may be used as the target direction. Additionally, or alternatively, a user may provide the target direction using, e.g., a pointing device (such as a mouse), a helmet or goggle-based movement capture system to identify an eye-based gesture (e.g., using a gaze-tracking system in a helmet or goggle-based interface), and/or a head or body-based gesture, movement tracking (e.g., a gesture made by a hand/arm/etc.) using vision sensors, inertial sensors (e.g., an inertial measurement unit, gyroscope, etc.), touch sensors, or other sensors, voice commands detected using a microphone, or other input techniques. In some embodiments, the user may specify how close to the target direction the primary direction is to be in order to trigger image capture. For example, if the primary direction is within an angular margin (e.g., 15 degrees, 30 degrees, 45 degrees, or other margin), then image capture may be performed. In some embodiments, UI 1201 may enable the user to specify that image capture is to be performed upon detection of movement in any direction.

In some embodiments, UI 1201 may receive speed thresholds from the user which may be used to determine movement and static thresholds, as discussed above. In some embodiments, UI 1201 may also be used to determine when to trigger image capture relative to the thresholds. For example, embodiments have been described in which images are captured after an ROI falls below a static threshold following detected motion that exceeded a motion threshold. However, in various embodiments, other movement sequences may be specified through UI 1201 to trigger image capture. For example, image capture may be triggered upon detecting movement from being static. In some embodiments, the user may specify whether image capture is to be performed only when the direction criteria is met, when the speed criteria is met, or both.

Image manager 115 can analyze image data as it is received from camera 124 (e.g., live image data 1210) or stored image data 1212 that has been previously stored in a buffer 205 or other data store, memory, etc. In some embodiments, the live image data may be a lower quality (e.g., resolution or other image characteristics) so as to require less storage space to stream the data in (e.g., a smaller memory footprint, display buffer, etc.). Camera 124 may capture image data using an image sensor 1203. Image sensor 1203 may be a charged coupled device (CCD) sensor, complementary metal-oxide-semiconductor (CMOS) sensor, or other image sensor. As discussed above, the image manager can identify a region of interest (ROI) can generate a bounding box that encloses the ROI. For example, facial recognition techniques may be used to identify one or more faces in the image data. Once one or more faces have been identified, body recognition techniques can be used to expand the bounding box to include the bodies of the people shown in the image. Additionally, or alternatively, a user may provide an arbitrary bounding box through image manager UI 1201 (e.g., by drawing an outline around one or more objects shown in image data on the image manager UI).

In some embodiments, camera 124 may include multiple image sensors 1203, 1205. Image sensor 1203 may be used to capture images for analysis (e.g., provide live view image data to image manager 115) and image sensor 1205 may be used to capture image data upon being triggered by detected motion of the ROI. For example, image sensor 1203 may be a lower resolution image sensor capable of being used to identify an ROI and track its movement, while image sensor 1205 may be a higher resolution image sensor to capture high quality images. Each sensor may be associated with a separately controllable shutter. For example, the shutter associated with image sensor 1205 may be triggered by image manager 115 upon detection of motion in image data captured by image sensor 1203.

Image manager 115 may analyze the image data (either received live or previously stored) to determine movement characteristics of the ROI from frame to frame. As discussed above, the movement characteristics may include a movement magnitude and a movement direction. The movement magnitude may be determined by analyzing optical flow vectors for some or all pixels in the ROI (e.g., inside the bounding box), from one frame to the next. If the magnitude of a threshold percentage of these vectors (e.g., 30%, 50% or other value) is greater than a magnitude threshold then the ROI can be considered to be moving. As discussed, the magnitude threshold may be determined using depth information (e.g., a distance between the target objects 302 and the camera 124) using sensor data, stereoscopic vision, or other techniques. Additionally, a movement direction characteristic can also be determined by analyzing the optical flow vectors of pixels in the ROI from frame to frame, as discussed above.

In some embodiments, camera 124 can be triggered to capture image data and store the image data to a persistent storage location based on the movement characteristics. For example, the live image data 1210 may be analyzed by image manager 115 to determine a magnitude and direction of movement of the ROI. Triggers may be set on the magnitude and/or direction of the movement of the ROI. For example, movement in a target direction greater than a target magnitude may cause the camera 124 to capture and store image data in buffer 205. In some embodiments, this stored image data may be higher quality image data than the live image data. Additionally, or alternatively, the camera 124 may be triggered to capture image data if movement of a target magnitude is detected in any direction. Likewise, the camera 124 may be triggered to capture image data if movement in a target direction is detected regardless of detected magnitude. As discussed above, movement detected within a configurable margin of the target direction may cause image capture. By capturing high quality image data only once movement has been identified, less storage space may be required to be maintained by the movable object or client device, improving performance of the system.

Once the image data has been captured, image manager 115 can analyze to image data to identify one or more images 1202 from the image data. In some embodiments, a user may configure image manager 115 to identify one image or multiple images. For example, a maximum movement magnitude may be identified for the ROI in the image data and a time recorded. A subset of image frames from the image data may then be selected based on proximity to the time at which the movement magnitude was at its maximum (e.g., based on a configurable temporal threshold about the recorded time). For example, in a scene where the ROI includes one or more people, and the movement is a jumping motion, a time may be determined when the jump is at or near its highest (e.g., when motion has slowed or substantially stopped). The subset of image frames may then be further analyzed to determine one or more “best” images. For example, each image may be scored based on various factors (sharpness, facial characteristics, etc.) and the scores may be combined (e.g., summed, weighted average, etc.). The image having the highest score may then be provided as image 1202. In some embodiments, images may be scored using a machine learning model trained using high scoring images. The selected images may be presented to the user (e.g., via user interface 1201, a remote controller, or other application and/or user interface). The user may be allowed to further select an image from the presented images. In some embodiments, the user can score the presented images. The user's selection and/or user scores may be used to train the machine learning model. In some embodiments, the criteria used to identify a “best” image may be provided by the user through user interface 1201 (e.g., a user may select which criteria to use, how those criteria may be weighted, etc.).

As shown in FIG. 12B, in some embodiments, a system for automatic image capture based on movement may include multiple cameras 1212. These cameras may be co-located (e.g., included in a common housing) or may be located separately on a movable object or other platform. When mounted at separate locations, the cameras may have a predetermined spatial relationship with each other based on their locations on the movable object or other platform. In some embodiments, the cameras may be coupled to the movable object, or other platform, using the same carrier (such as a gimbal or other mount). In some embodiments, each camera may be separately coupled to the moveable object or other platform. In some embodiments, at least one camera may be located separately from the movable object and transmit image data to the movable object where the image data may be used to trigger a camera coupled to the movable object. In some embodiments, the cameras 1212 may be configured to measure depth information (e.g., as a stereoscopic vision system)

In the example system shown in FIG. 12B, a first camera 1214 may be used to capture images for analysis (e.g., provide live view image data to image manager 115) and a second camera 1216 may be used to capture image data upon being triggered by detected motion of the ROI. For example, first camera 1214 may capture lower resolution image data capable of being used to identify an ROI and track its movement, while second camera 1216 may capture high quality images.

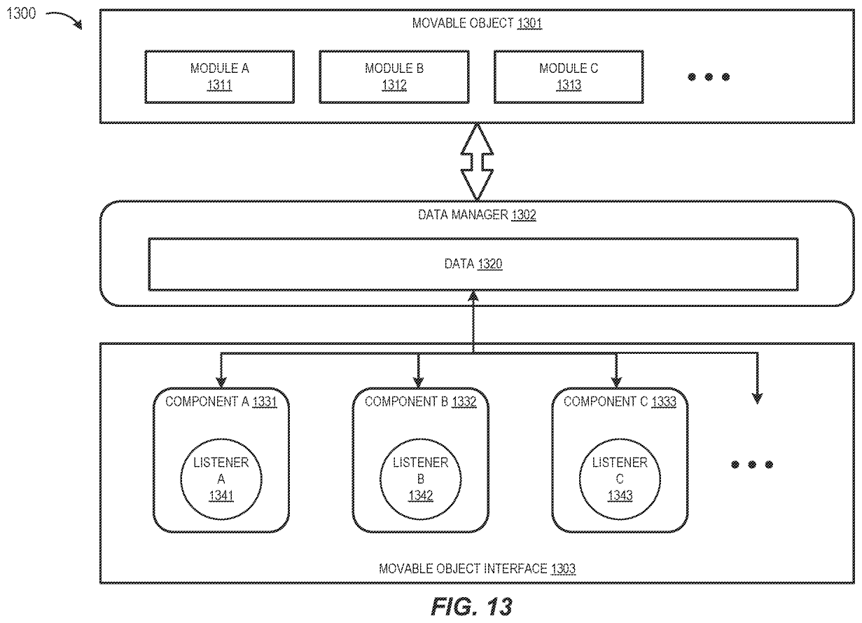

FIG. 13 illustrates an example of supporting a movable object interface in a software development environment, in accordance with various embodiments of the present invention. As shown in FIG. 13, a movable object interface 1303 can be used for providing access to a movable object 1301 in a software development environment 1300, such as a software development kit (SDK) environment. The image manager can be provided as part of an SDK or onboard SDK, or may utilize the SDK, to enable all or portions of these custom actions to be performed directly on the movable object, reducing latency and improving performance.

Furthermore, the movable object 1301 can include various functional modules A-C 1311-1313, and the movable object interface 1303 can include different interfacing components A-C 1331-1333. Each said interfacing component A-C 1331-1333 in the movable object interface 1303 can represent a module A-C 1311-1313 in the movable object 1301.

In accordance with various embodiments of the present invention, the movable object interface 1303 can provide one or more callback functions for supporting a distributed computing model between the application and movable object 1301.

The callback functions can be used by an application for confirming whether the movable object 1301 has received the commands. Also, the callback functions can be used by an application for receiving the execution results. Thus, the application and the movable object 1301 can interact even though they are separated in space and in logic.

As shown in FIG. 13, the interfacing components A-C 1331-1333 can be associated with the listeners A-C 1341-1343. A listener A-C 1341-1343 can inform an interfacing component A-C 1331-1333 to use a corresponding callback function to receive information from the related module(s).

Additionally, a data manager 1302, which prepares data 1320 for the movable object interface 1303, can decouple and package the related functionalities of the movable object 1301. Also, the data manager 1302 can be used for managing the data exchange between the applications and the movable object 1301. Thus, the application developer does not need to be involved in the complex data exchanging process.

For example, the SDK can provide a series of callback functions for communicating instance messages and for receiving the execution results from an unmanned aircraft. The SDK can configure the life cycle for the callback functions in order to make sure that the information interchange is stable and completed. For example, the SDK can establish connection between an unmanned aircraft and an application on a smart phone (e.g. using an Android system or an iOS system). Following the life cycle of a smart phone system, the callback functions, such as the ones receiving information from the unmanned aircraft, can take advantage of the patterns in the smart phone system and update the statements accordingly to the different stages in the life cycle of the smart phone system.

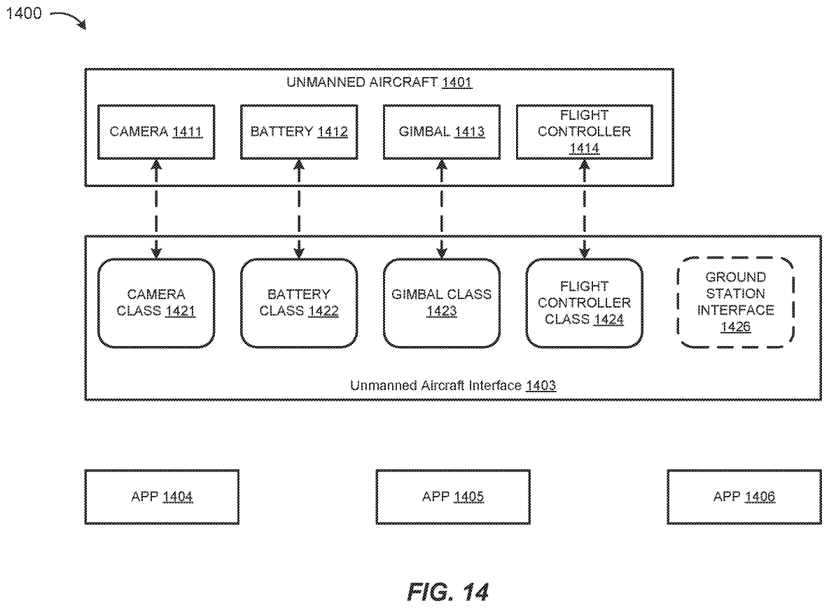

FIG. 14 illustrates an example of an unmanned aircraft interface, in accordance with various embodiments. As shown in FIG. 14, an unmanned aircraft interface 1403 can represent an unmanned aircraft 1401. Thus, the applications, e.g. APPs 1404-1407, in the unmanned aircraft environment 1400 can access and control the unmanned aircraft 1401. As discussed, these apps may include an inspection app 1404, a viewing app 1405, and a calibration app 1406.

For example, the unmanned aircraft 1401 can include various modules, such as a camera 1411, a battery 1412, a gimbal 1413, and a flight controller 1414.

Correspondently, the movable object interface 1403 can include a camera component 1421, a battery component 1422, a gimbal component 1423, and a flight controller component 1424.

Additionally, the movable object interface 1403 can include a ground station component 1426, which is associated with the flight controller component 1424. The ground station component operates to perform one or more flight control operations, which may require a high-level privilege.

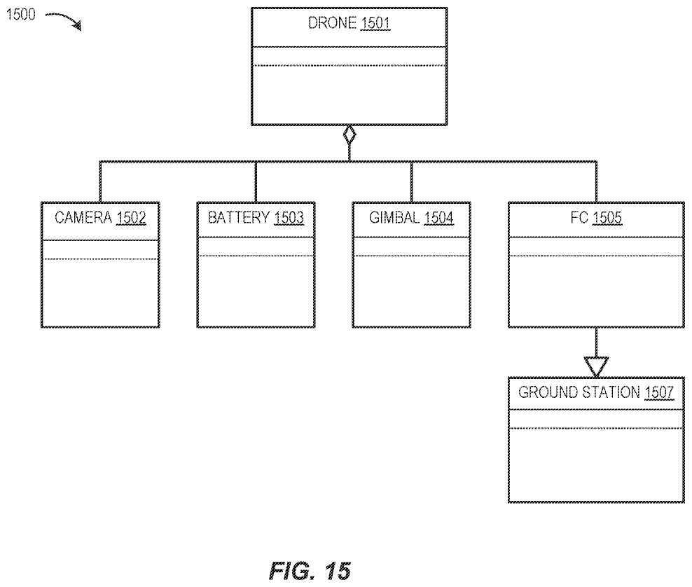

FIG. 15 illustrates an example of components for an unmanned aircraft in a software development kit (SDK), in accordance with various embodiments. As shown in FIG. 15, the drone class 1501 in the SDK 1500 is an aggregation of other components 1502-1507 for an unmanned aircraft (or a drone). The drone class 1501, which have access to the other components 1502-1507, can exchange information with the other components 1502-1507 and controls the other components 1502-1507.

In accordance with various embodiments, an application may be accessible to only one instance of the drone class 1501. Alternatively, multiple instances of the drone class 1501 can present in an application.

In the SDK, an application can connect to the instance of the drone class 1501 in order to upload the controlling commands to the unmanned aircraft. For example, the SDK may include a function for establishing the connection to the unmanned aircraft. Also, the SDK can disconnect the connection to the unmanned aircraft using an end connection function. After connecting to the unmanned aircraft, the developer can have access to the other classes (e.g. the camera class 1502 and the gimbal class 1504). Then, the drone class 1501 can be used for invoking the specific functions, e.g. providing access data which can be used by the flight controller to control the behavior, and/or limit the movement, of the unmanned aircraft.

In accordance with various embodiments, an application can use a battery class 1503 for controlling the power source of an unmanned aircraft. Also, the application can use the battery class 1503 for planning and testing the schedule for various flight tasks.

As battery is one of the most restricted elements in an unmanned aircraft, the application may seriously consider the status of battery not only for the safety of the unmanned aircraft but also for making sure that the unmanned aircraft can finish the designated tasks. For example, the battery class 1503 can be configured such that if the battery level is low, the unmanned aircraft can terminate the tasks and go home outright.

Using the SDK, the application can obtain the current status and information of the battery by invoking a function to request information from in the Drone Battery Class. In some embodiments, the SDK can include a function for controlling the frequency of such feedback.

In accordance with various embodiments, an application can use a camera class 1502 for defining various operations on the camera in a movable object, such as an unmanned aircraft. For example, in SDK, the Camera Class includes functions for receiving media data in SD card, getting & setting photo parameters, taking photo and recording videos.

An application can use the camera class 1502 for modifying the setting of photos and records. For example, the SDK may include a function that enables the developer to adjust the size of photos taken. Also, an application can use a media class for maintaining the photos and records.

In accordance with various embodiments, an application can use a gimbal class 1504 for controlling the view of the unmanned aircraft. For example, the Gimbal Class can be used for configuring an actual view, e.g. setting a first personal view of the unmanned aircraft. Also, the Gimbal Class can be used for automatically stabilizing the gimbal, in order to be focused on one direction. Also, the application can use the Gimbal Class to change the angle of view for detecting different objects.

In accordance with various embodiments, an application can use a flight controller class 1505 for providing various flight control information and status about the unmanned aircraft. As discussed, the flight controller class can include functions for receiving and/or requesting access data to be used to control the movement of the unmanned aircraft across various regions in an unmanned aircraft environment.

Using the Main Controller Class, an application can monitor the flight status, e.g. using instant messages. For example, the callback function in the Main Controller Class can send back the instant message every one thousand milliseconds (1000 ms).

Furthermore, the Main Controller Class allows a user of the application to investigate the instance message received from the unmanned aircraft. For example, the pilots can analyze the data for each flight in order to further improve their flying skills.

In accordance with various embodiments, an application can use a ground station class 1507 to perform a series of operations for controlling the unmanned aircraft.

For example, the SDK may require applications to have a SDK-LEVEL-2 key for using the Ground Station Class. The Ground Station Class can provide one-key-fly, on-key-go-home, manually controlling the drone by app (i.e. joystick mode), setting up a cruise and/or waypoints, and various other task scheduling functionalities.

In accordance with various embodiments, an application can use a communication component for establishing the network connection between the application and the unmanned aircraft.

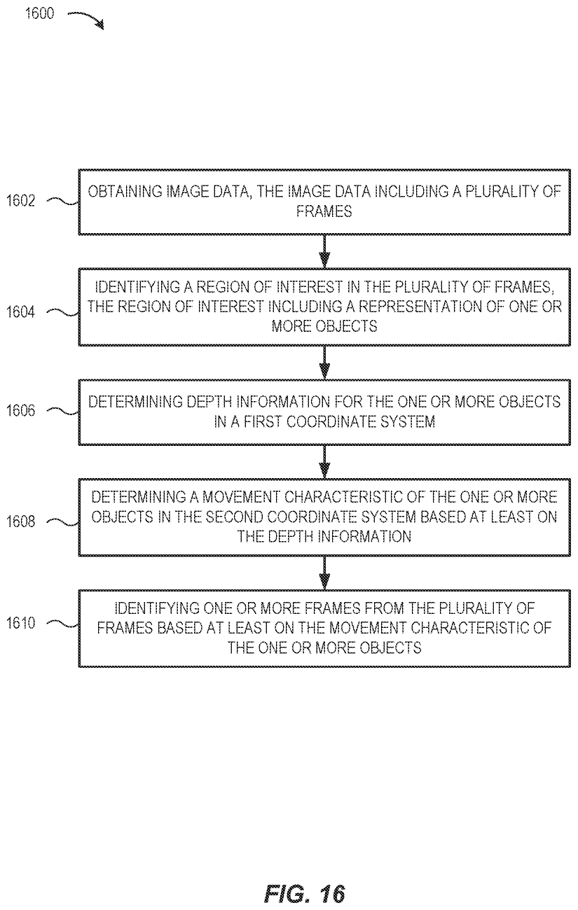

FIG. 16 shows a flowchart 1600 of communication management in a movable object environment, in accordance with various embodiments. At 1602, the method comprises obtaining image data, the image data including a plurality of frames. In some embodiments, obtaining image data further comprises receiving a live image stream, the live image steam including a representation of the one or more objects, determining the movement characteristic using the live image stream, and triggering the image capture device to capture the image data based on the movement characteristic.

At 1604, the method comprises identifying a region of interest in the plurality of frames, the region of interest including a representation of one or more objects. At 1606, the method comprises determining depth information for the one or more objects in a first coordinate system. In some embodiments, determining depth information for the one or more objects in a first coordinate system further comprises calculating a depth value for the one or more objects in the plurality of frames using at least one of a stereoscopic vision system, a rangefinder, LiDAR, or RADAR.

At 1608, the method comprises determining a movement characteristic of the one or more objects in the second coordinate system based at least on the depth information. In some embodiments, determining a movement characteristic of the one or more objects in the second coordinate system based at least on the depth information further comprises calculating a movement threshold in the second coordinate system by transforming a movement threshold in the first coordinate system using the depth value, and calculating a static threshold in the second coordinate system by transforming a static threshold in the first coordinate system using the depth value.

At 1610, the method comprises identifying one or more frames from the plurality of frames based at least on the movement characteristic of the one or more objects. In some embodiments, identifying one or more frames from the plurality of frames based at least on the movement characteristic of the one or more objects further comprises determining a first time in which the magnitude of the motion associated with the region of interest is greater than the movement threshold, determining a second time in which the magnitude of the motion associated with the region of interest is less than the static threshold, determining a third time in which the magnitude of the motion associated with the region of interest is greater than the movement threshold, and identifying the one or more frames captured between the first time and the third time.

In some embodiments, determining a movement characteristic of the one or more objects in the second coordinate system based at least on the depth information further comprises determining that a direction of the motion corresponds to a target direction. In some embodiments, determining a direction of the motion corresponds to a target direction further comprises for each pixel of the image data in the region of interest determining a two-dimensional vector representing a movement of the pixel in the second coordinate system, calculating weights associated with the two-dimensional vector, each weight associated with a different component direction of the two-dimensional vector, combining the weights calculated for each pixel along each component direction, and determining the direction of the motion of the region of interest, the direction of the motion corresponding to the component direction having a highest combined weight.

In some embodiments, the method may further comprise scoring the one or more frames based on at least one of image sharpness, facial recognition, or a machine learning technique, and selecting a first frame from the one or more frames having a highest score. In some embodiments, the method may further comprise receiving a gesture-based input through a user interface, and determining a target direction based on a direction associated with the gesture-based input. In some embodiments, the method may further comprise storing the image data in a first data store, and storing the one or more frames in a second data store.

Many features of the present invention can be performed in, using, or with the assistance of hardware, software, firmware, or combinations thereof. Consequently, features of the present invention may be implemented using a processing system (e.g., including one or more processors). Exemplary processors can include, without limitation, one or more general purpose microprocessors (for example, single or multi-core processors), application-specific integrated circuits, application-specific instruction-set processors, graphics processing units, physics processing units, digital signal processing units, coprocessors, network processing units, audio processing units, encryption processing units, and the like.

Features of the present invention can be implemented in, using, or with the assistance of a computer program product which is a storage medium (media) or computer readable medium (media) having instructions stored thereon/in which can be used to program a processing system to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the machine readable medium (media), features of the present invention can be incorporated in software and/or firmware for controlling the hardware of a processing system, and for enabling a processing system to interact with other mechanism utilizing the results of the present invention. Such software or firmware may include, but is not limited to, application code, device drivers, operating systems and execution environments/containers.

Features of the invention may also be implemented in hardware using, for example, hardware components such as application specific integrated circuits (ASICs) and field-programmable gate array (FPGA) devices. Implementation of the hardware state machine so as to perform the functions described herein will be apparent to persons skilled in the relevant art.

Additionally, the present invention may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

While various embodiments of the present invention have been described above, it should be understood that they have been presented by way of example, and not limitation. It will be apparent to persons skilled in the relevant art that various changes in form and detail can be made therein without departing from the spirit and scope of the invention.

The present invention has been described above with the aid of functional building blocks illustrating the performance of specified functions and relationships thereof. The boundaries of these functional building blocks have often been arbitrarily defined herein for the convenience of the description. Alternate boundaries can be defined so long as the specified functions and relationships thereof are appropriately performed. Any such alternate boundaries are thus within the scope and spirit of the invention.

The foregoing description of the present invention has been provided for the purposes of illustration and description. It is not intended to be exhaustive or to limit the invention to the precise forms disclosed. The breadth and scope of the present invention should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

What is claimed is:

1. A system for capturing image data in a movable object environment, comprising:
at least one movable object including an image capture device and an onboard computing device in communication with the image capture device, the onboard computing device including a processor and an image manager, the image manager including instructions which, when executed by the processor, cause the image manager to:
obtain image data, the image data including a plurality of frames;
identify a region of interest in the plurality of frames, the region of interest including a representation of one or more objects;
determine depth information for the one or more objects in a first coordinate system;
determine a movement characteristic of the one or more objects in a second coordinate system based at least on the depth information; and
identify one or more frames from the plurality of frames based at least on the movement characteristic of the one or more objects.

2. The system of claim 1, wherein the instructions to determine depth information for the one or more objects in a first coordinate system, when executed, further cause the image manager to:
calculate a depth value for the one or more objects in the plurality of frames using at least one of a stereoscopic vision system, a rangefinder, LiDAR, or RADAR.

3. The system of claim 2, wherein the instructions to determine a movement characteristic of the one or more objects in the second coordinate system based at least on the depth information, when executed, further cause the image manager to:
calculate a movement threshold in the second coordinate system by transforming a movement threshold in the first coordinate system using the depth value; and
calculate a static threshold in the second coordinate system by transforming a static threshold in the first coordinate system using the depth value.

4. The system of claim 3, wherein the instructions to identify one or more frames from the plurality of frames based at least on the movement characteristic of the one or more objects, when executed, further cause the image manager to:
determine a first time in which a magnitude of a motion associated with the region of interest is greater than the movement threshold;
determine a second time in which the magnitude of the motion associated with the region of interest is less than the static threshold;
determine a third time in which the magnitude of the motion associated with the region of interest is greater than the movement threshold; and
identify the one or more frames captured between the first time and the third time.

5. The system of claim 1, wherein the instructions, when executed, further cause the image manager to:
score the one or more frames based on at least one of image sharpness, facial recognition, or a machine learning technique; and
select a first frame from the one or more frames having a highest score.

6. The system of claim 1, wherein the instructions to obtain image data, when executed, further cause the image manager to:
receive a live image stream, the live image steam including a representation of the one or more objects;
determine the movement characteristic using the live image stream; and
trigger the image capture device to capture the image data based on the movement characteristic.

7. The system of claim 1, wherein the instructions, when executed, further cause the image manager to:
storing the image data in a first data store; and
storing the one or more frames in a second data store.

8. A method for capturing images in a movable object environment, comprising:
obtaining image data, the image data including a plurality of frames;
identifying a region of interest in the plurality of frames, the region of interest including a representation of one or more objects;
determining depth information for the one or more objects in a first coordinate system;
determining a movement characteristic of the one or more objects in a second coordinate system based at least on the depth information; and
identifying one or more frames from the plurality of frames based at least on the movement characteristic of the one or more objects.

9. The method of claim 8, wherein determining depth information for the one or more objects in a first coordinate system further comprises:
calculating a depth value for the one or more objects in the plurality of frames using at least one of a stereoscopic vision system, a rangefinder, LiDAR, or RADAR.

10. The method of claim 9, determining a movement characteristic of the one or more objects in the second coordinate system based at least on the depth information further comprises:
calculating a movement threshold in the second coordinate system by transforming a movement threshold in the first coordinate system using the depth value; and
calculating a static threshold in the second coordinate system by transforming a static threshold in the first coordinate system using the depth value.

11. The method of claim 10, identifying one or more frames from the plurality of frames based at least on the movement characteristic of the one or more objects further comprises:
determining a first time in which a magnitude of a motion associated with the region of interest is greater than the movement threshold;
determining a second time in which the magnitude of the motion associated with the region of interest is less than the static threshold;
determining a third time in which the magnitude of the motion associated with the region of interest is greater than the movement threshold; and
identifying the one or more frames captured between the first time and the third time.

12. The method of claim 8, further comprising:
scoring the one or more frames based on at least one of image sharpness, facial recognition, or a machine learning technique; and
selecting a first frame from the one or more frames having a highest score.

13. The method of claim 8, wherein obtaining image data further comprises:
receiving a live image stream, the live image steam including a representation of the one or more objects;
determining the movement characteristic using the live image stream; and
triggering an image capture device to capture the image data based on the movement characteristic.

14. The method of claim 8, further comprising:
storing the image data in a first data store; and
storing the one or more frames in a second data store.

15. A non-transitory computer readable storage medium including instructions stored thereon which, when executed by one or more processors, cause the one or more processors to:
obtain image data, the image data including a plurality of frames;
identify a region of interest in the plurality of frames, the region of interest including a representation of one or more objects;
determine depth information for the one or more objects in a first coordinate system;
determine a movement characteristic of the one or more objects in a second coordinate system based at least on the depth information; and
identify one or more frames from the plurality of frames based at least on the movement characteristic of the one or more objects.

16. The non-transitory computer readable storage medium of claim 15, wherein the instructions to determine depth information for the one or more objects in a first coordinate system, when executed, further cause the one or more processors to:
calculate a depth value for the one or more objects in the plurality of frames using at least one of a stereoscopic vision system, a rangefinder, LiDAR, or RADAR;
calculate a movement threshold in the second coordinate system by transforming a movement threshold in the first coordinate system using the depth value; and
calculate a static threshold in the second coordinate system by transforming a static threshold in the first coordinate system using the depth value.

17. The non-transitory computer readable storage medium of claim 16, wherein the instructions to identify one or more frames from the plurality of frames based at least on the movement characteristic of the one or more objects, when executed, further cause the one or more processors to:
determine a first time in which a magnitude of a motion associated with the region of interest is greater than the movement threshold;
determine a second time in which the magnitude of the motion associated with the region of interest is less than the static threshold;
determine a third time in which the magnitude of the motion associated with the region of interest is greater than the movement threshold; and
identify the one or more frames captured between the first time and the third time.

18. The non-transitory computer readable storage medium of claim 16, wherein the instructions, to determine a movement characteristic of the one or more objects in the second coordinate system based at least on the depth information, when executed, further cause the one or more processors to:
determine that a direction of a motion corresponds to a target direction.

19. The non-transitory computer readable storage medium of claim 18, wherein the instructions to determine a direction of a motion corresponds to a target direction, when executed, further cause the one or more processors to:
for each pixel of the image data in the region of interest:
determine a two-dimensional vector representing a movement of the pixel in the second coordinate system;
calculate weights associated with the two-dimensional vector, each weight associated with a different component direction of the two-dimensional vector;
combine the weights calculated for each pixel along each component direction; and
determine the direction of the motion of the region of interest, the direction of the motion corresponding to the component direction having a highest combined weight.

20. The non-transitory computer readable storage medium of claim 18, wherein the instructions, when executed, further cause the one or more processors to:
receive a gesture-based input through a user interface; and
determine the target direction based on a direction associated with the gesture-based input.
